(19) United States
(12) Patent Application Publication
(10) Pub. No.: US 2014/0322159 A1
(43) Pub. Date: Oct. 30, 2014

(54) ODORS FOR PSYLLID TRAPPING, REPELLING AND CONTROL

(71) Applicant: The Regents of the University of California, Oakland, CA (US)

(72) Inventors: Anandasankar Ray, Riverside, CA (US); Lisa Forster, Riverside, CA (US); Iliano Vieira Coutinho Abreu Gomes, Riverside, CA (US)

(73) Assignee: The Regents of the University of California, Oakland, CA (US)

(21) Appl. No.: 14/351,642

(22) PCT Filed: Oct. 12, 2012
(86) PCT No.: PCT/US2012/060130

§ 371 Date: Apr. 14, 2014

Related U.S. Application Data
(60) Provisional application No. 61/547,559, filed on Oct. 14, 2011.

(51) Int. Cl. A01M 1/02; A01N 37/02; A01N 35/04; A01N 35/06; A01M 29/12; A01N 35/02; A01N 41/12; A01N 43/40; A01N 33/04; A01N 27/00; A01N 31/02

(52) U.S. Cl. CPC A01M 1/02; A01N 27/00; A01N 37/02; A01N 35/04; A01N 35/06; A01N 31/02; A01N 35/02; A01N 41/12; A01N 43/40; A01N 33/04; A01M 29/12
USPC 424/84; 514/315

(57) ABSTRACT

The disclosure provides methods and compositions for modifying psyllid behavior. In addition, the disclosure provides methods and volatile odorants useful for repelling or attracting psyllids.

### CROSS REFERENCE TO RELATED APPLICATIONS

This application claims the benefit under 35 U.S.C. §119(e) of U.S. Provisional Application Ser. No. 61/547,559, filed Oct. 14, 2011, the disclosure of which is hereby incorporated by reference in its entirety.

### TECHNICAL FIELD

The disclosure relates methods and compositions for attracting and repelling psyllids, such as, for example, Asian Citrus Psyllids (ACPs), and inhibiting the spread of Huanglongbing disease in plants and trees.

### BACKGROUND

Citrus greening, also called Huanglongbing (HLB) or yellow dragon disease, is a disease of citrus. This bacterial disease is thought to have originated in China in the early 1900's. The disease is primarily spread by two species of psyllid insects. One species, the Asian citrus psyllid, Diaphorina citri, has been present in Florida since 1998. The bacteria that cause HLB itself are not harmful to humans but the disease is damaging to the citrus crops. There are three strains of the bacteria: an Asian version, an African version, and a recently described American strain discovered in Brazil.

The Asian strain, Candidatus Liberibacter asialicus, was found in Florida in early September, 2005. As a result, HLB is becoming a major threat to the U.S. citrus industry. Other than tree removal, there are no known effective controls once a tree is infected and there has been no known cure for the disease. Infected trees may produce misshapen, unmarketable, bitter fruit. HLB reduces the quantity and quality of citrus fruits, eventually rendering infected trees useless. In areas of the world affected by HLB the average productive lifespan of citrus trees has dropped from 50 or more years to 15 or less. The trees in the orchards usually die 3-5 years after becoming infected and require removal and replanting. An infected tree produces fruit that is unsuitable for sale as fresh fruit or for juice.

Citrus plants infected by the HLB bacteria may not show symptoms for years following infection. Initial symptoms frequently include the appearance of yellow shoots on a tree. As the bacteria move within the tree, the entire canopy progressively develops a yellow color.

The most characteristic symptoms of HLB are a blotchy leaf mottle and vein yellowing that develop on leaves attached to shoots, providing the overall yellow appearance. These foliar symptoms may superficially resemble a zinc deficiency although the green and yellow contrast is not as vivid with greening as it is with zinc deficiency or another disease, citrus variegated chlorosis. Leaves with HLB have a mottled appearance that differs from nutrition-related mottling in that greening-induced mottling usually crosses leaf veins. Nutrition related mottles usually are found between or along leaf veins and leaves may be small and upright.

Fruit from diseased trees are small, often misshapen, and typically some green color remains on ripened fruit. On Mandarin orange, fruit may develop an uneven ripening such that they appear half orange and half yellow. This symptom is the origin of the common name “greening.” Yields are almost minimal, and any developed fruit is rendered worthless due to small size, poor color, and bad taste.

Among the volatiles released by guava and garlic chive leaves that induce repellence to ACP, dimethyl disulfide (DMDS) has been assayed in a small plot field trial and led to reduction in ACP densities for up to three weeks. This field trial was performed on an low psyllid density area (average: 3-4 ACP/10 trees) and resulted in only 65% reduction in ACP densities which indicates DMDS treatment may not be effective as a repellent to effectively control ACP in citrus plantations. Additionally, DMDS has strong and unpleasant odor and its toxic effect (DMDS-MSDS) may also preclude deployment of DMDS in citrus producing areas.

Methyl salicylate is another compound that has been identified as both an ACP attractant and repellent. Methyl salicylate is a chemical released in high amounts by citrus plants under physical stress, leading to ACP repellency in laboratory behavioral assays. On the other hand, at lower concentration ACP is attracted to it in lab behavior assays. It is not known whether this compound will serve as an attractant or repellent in the field.

Therefore, there is a need for psyllid (e.g., Asian Citrus Psyllid) trapping, repelling, and control agents that are environmentally safe, inexpensive, and usable in conjunction with other control methods. This is the object of the methods disclosed herein.

### SUMMARY

The disclosure provides a comprehensive set of odor receptor neuron ligands for the psyllid set forth in the tables herein.

The disclosure provides an insect repellent comprising: a compound selected from the group consisting of a selected citrus volatile, a selected guava volatile, a selected synthetic compound, and any combination thereof. In one embodiment, the citrus volatile is selected from the group consisting of Sabinene, α-Humulene, β-Caryophyllene, (E)-β-Ocimene, Myrcene, Terpinolene, α-Terpinol, β-Cymene, δ-3-Carene, Octanal, E-2-Hexenal, Limonene (+), γ-Terpinene, Citral, Citronellal, Limonene (−), Acetic Acid, Pentyl Acetate, Acetophenone, Isobutyl Acetate, 3-Methyl-1-Butanol, 1-Hexanol, Ethyl Butyrate, Dipropyldisulfide, (Z)-2-Hexanol, Propionic acid, (+)-Carvone, Methyl Butyrate, α-Terpinene, Nonanal, and (Z)-3-Hexen-1-ol. In another embodiment, the guava volatile is selected from the group consisting of (Z)-3-Hexenal, Benzaldehyde, and (E,E)-2,4-Hexadienal. In yet another embodiment, the synthetic compound is selected from the group consisting of Methyl Salicylate and Isobutyric Acid. In further embodiments, the insect repellent or ligand is formulated as a lotion, a cream, a spray or a dust. In yet a further embodiment, the insect repellent or ligand comprises a vaporizer, a treated mat, treated outerwear, an oil, a candle, or a wicked apparatus.

The disclosure also provides an insect trap comprising a compound selected from the group consisting of a citrus volatile, a guava volatile, a synthetic compound, and any combination thereof. In one embodiment, the citrus volatile is selected from the group consisting of Sabinene, α-Humulene, β-Caryophyllene, (E)-β-Ocimene, Myrcene, Terpinolene, α-Terpinol, β-Cymene. δ-3-Carene, Octanal, E-2-Hexenal, Limonene (+), γ-Terpinene, Geranial (Syn. Citral), Citronellal, Limonene (−), Acetic Acid, Pentyl Acetate, Acetophenone, Isobutyl Acetate, 3-Methyl-1-Butanol, 1-Hexanol, Ethyl Butyrate, Dipropyldisulfide, (Z)-2-Hexanol, Propionic acid, (+)-Carvone, Methyl Butyrate, α-Terpinene, Nonanal, and (Z)-3-Hexen-1-ol. In another embodiment, the guava volatile is selected from the group consisting Z-3-Hexenal, Benzaldehyde, and (E,E)-2,4-Hexadienal. In yet another embodiment, the synthetic compound is selected from the group consisting of Methyl Salicylate and Isobutyric Acid. In various other embodiments, the insect trap comprises a trapping agent emitted from vaporizers, treated mats, treated pods, absorbed material, cylinders, oils, candles, wicked apparatus, fans, within or near trap entrances. In yet another embodiment, of the insect trap the trapping agent is a liquid source that can evaporate to form vapors within or near trap entrances. In another embodiment, the insect trap is suction based, light based, electric current based.

The disclosure also provides a method of repelling an insect pest, comprising applying to an object, in an amount effect to repel said insect pest, a compound identified herein.

The disclosure also provides a method of repelling psyllids, comprising applying to an object a compound selected form the group consisting of a citrus volatile, a guava volatile, a natural volatile, a synthetic volatile, and any combination thereof. In one embodiment, the psyllid comprises the Asian Citrus Psyllid. In another embodiment, the psyllid comprises the Asian Citrus Psyllid Diaphorina citri. In another embodiment, the object is a citrus plant. In another embodiment, the repellant is applied to a citrus plant. In another embodiment, the applying comprises application of the repellant to an article, which article is suspended on a citrus plant.

The disclosure provides for a method of attracting a psyllid comprising exposing the psyllid with an attracting composition comprising one or more compounds listed in Table 1. The disclosure also provides for a method of attracting a psyllid comprising exposing the psyllid with a psyllid attracting composition comprising two or more compounds each independently selected from the group consisting of a C10-C15 terpene; a C10-C15 terpenoid; a C6-C8 alcohol; a C5-C7 ester; a C7-C10 compound containing an aromatic ring; a C6-C10 aldehyde; a C5-C8 ketone; and a S2-S3. C6 sulfur compound. In some embodiments, the attracting composition comprises two or more compounds listed in Table 1. In other embodiments the attracting composition comprises p-cymene, ethyl butyrate, and myrcene. In other embodiments, the attracting composition comprises acetophenone, p-cymene, ethyl butyrate, and myrcene. In other embodiments the attracting composition comprises one or more compounds selected from the group consisting of myrcene, δ-3-carene, terpinolene, (E)-β-ocimene, β-caryophyllene, α-humulene, and D-limonene. In other embodiments, the attracting composition comprises δ-3-carene and terpinolene. In other embodiments, the attracting composition comprises (E)-β-ocimene, β-caryophyllene, and α-humulene. In other embodiments, the attracting composition comprises δ-3-carene, terpinolene, β-caryophyllene, and α-humulene. In other embodiments, the attracting composition comprises myrcene, δ-3-carene, (E)-β-ocimene, and D-limonene. In other embodiments, the attracting composition comprises myrcene, δ-3-carene, terpinolene, (E)-β-ocimene, β-caryophyllene, α-humulene, and D-limonene. In other embodiments, the psyllid attracting composition comprises a vapor, and wherein the vapor is emitted from a vaporizer, treated mat, treated pod, absorbed material, cylinder, oil, candle, wicked apparatus, or fan. In other embodiments, the psyllid attracting composition comprises a liquid, and wherein the liquid evaporates to a vapor within or near a psyllid trap entrance. In other embodiments, the exposing the psyllid with the psyllid attracting composition is carried out using suction, light, an electric current, or any combination thereof. In other embodiments, the psyllid is an Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and a psyllid of the family Psyllidae (Hemiptera). In other embodiments, the psyllid is an Asian Citrus Psyllid (Diaphorina citri). The disclosure also provides for an insect attractant composition comprising any compound disclosed above. In some embodiments, the insect attractant composition further comprises one or more compounds selected from the group consisting of (+)-carvone; 1-hexanol; and nonanal.

The disclosure also provides for a method of repelling a psyllid comprising exposing the psyllid with a psyllid repelling composition comprising one or more compounds each independently selected from the group consisting of a C4-C6 diketone; a C4 lactone; a C8-15 ester; a C2-C5 carboxylic acid; a C2-6 amine; and a C5-C6, N1-N2 heterocycle. In some embodiments, the psyllid repelling composition comprises one or more compounds selected from the group consisting of perillaldehyde; ethyl hexanoate; n-octyl acetate; isobutyric acid; propionic acid; acetic acid; pentanoic acid; 2,3-butanedione; β-butyrolactone; N-methylpiperidine; dimethyl amine; putrescine dihydrochloride; hexylamine; pentylamine; pyridine; (+)-carvone; 1-hexanol; and nonanal. In other embodiments, the psyllid repelling composition comprises one or more compounds selected from the group consisting of (+)-carvone; 1-hexanol; and nonanal. In other embodiments, wherein the psyllid repelling composition comprises one or more compounds selected from the group consisting of hexylamine, pentylamine, pyridine, 2-phenylethanamine, and dimethylamine. In other embodiments, wherein the psyllid repelling composition comprises one or more compounds selected from the group consisting of acetic acid and propionic acid. In other embodiments, wherein the psyllid repelling composition comprises one or more compounds selected from the group consisting of hexylamine, pentylamine, pyridine, 2-phenylethanamine, dimethylamine, acetic acid, and propionic acid. In other embodiments, the psyllid repelling composition comprises one or more compounds selected from the group consisting of perillaldehyde; ethyl hexanoate; n-octyl acetate; isobutyric acid; propionic acid; acetic acid; pentanoic acid; 2,3-butanedione; β-butyrolactone; N-methylpiperidine; dimethyl amine; putrescine dihydrochloride; hexylamine; pentylamine; and pyridine; and one or more compounds selected from the group consisting of (+)-carvone; 1-hexanol; and nonanal. In other embodiments, the psyllid repelling composition is formulated as a lotion, cream, spray, or dust. In other embodiments, the exposing the psyllid with the psyllid repelling composition is carried out using a vaporizer, a treated mat, treated outerwear, an oil, a candle, or a wicked apparatus. In other embodiments, the exposing the psyllid with the psyllid repelling composition comprises applying to an object an effective amount of the psyllid repelling composition to repel the psyllid. In other embodiments, the exposing comprises applying the psyllid repelling composition on or near a plant. In other embodiments, the exposing comprises applying the psyllid repelling composition to an article, and wherein the article is suspended on a citrus plant. In other embodiments, the psyllid is an Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and a psyllid of the family Psyllidae (Hemiptera). In other embodiments, the psyllid is an Asian Citrus Psyllid (Diaphorina citri). The disclosure also provides for an insect repellant composition comprising a compound of any one of above compounds. In some embodiments, the insect repellant composition comprises one or more compounds selected from the group consisting of (+)-carvone; 1-hexanol; and nonanal.

### BRIEF DESCRIPTION OF THE DRAWINGS

FIG. 1 depicts the olfactory system in the ACP. Scanning Electron micrograph of an ACP antenna (left), with a schematic indicating olfactory sensilla, and schematic of a single hair-like sensilla containing the dendrites of 3 neurons A, B and C with a recording electrode inserted. The antennal flagellomeres are numbered and the circles indicate the rhinarial plates with pit-like sensilla. Non-olfactory sensilla are smaller.

FIG. 2 shows representative traces from sensillum in rhinarial plate 6 of ACP showing responses to a 0.5 second stimulus (indicated by bars) of odors (dilution 1%). Neurons show specific activity to different odors: example of neuron activation (top) and neuron inhibition (bottom).

### DETAILED DESCRIPTION

As used herein and in the appended claims, the singular forms “a,” “and,” and “the” include plural referents unless the context clearly dictates otherwise. Thus, for example, reference to “a plant” includes a plurality of such plants and reference to “the tree” includes reference to one or more trees known to those skilled in the art, and so forth.

Unless defined otherwise, all technical and scientific terms used herein have the same meaning as commonly understood to one of ordinary skill in the art to which this disclosure belongs. Although any methods and reagents similar or equivalent to those described herein can be used in the practice of the disclosed methods and compositions, the exemplary methods and materials are now described.

Also, the use of “or” means “and/or” unless stated otherwise. Similarly, “comprise,” “comprises,” “comprising”, “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned herein are incorporated herein by reference in full for the purpose of describing and disclosing the methodologies, which are described in the publications, which might be used in connection with the description herein. However, with respect to any similar or identical terms found in both the incorporated publications or references and those expressly put forth or defined in this application, then those terms definitions or meanings expressly put forth in this application shall control in all respects. The publications discussed above and throughout the text are provided solely for their disclosure prior to the filing date of the present application. Nothing herein is to be construed as an admission that the inventors are not entitled to antedate such disclosure by virtue of prior disclosure.

Citrus greening or “Huanglongbing” (HLB), caused by bacteria Candidatus Liberobacter, is one of the most destructive diseases of citrus. Candidatus Liberibacter (C. Liberibacter) is a Gram negative bacterial pathogen restricted to the phloem. The uneven distribution within trees and the latency of detectable symptoms make detection and confirmation of asymptomatic infections very difficult. Therefore, developing early diagnosis biomarkers and effective reagents is an urgent need for the citrus industry, especially for those in the threatened but uninfected regions, such as California. The recent detection of psyllids (the insect vector for pathogen infection) at the California-Mexico border underlines the importance of our research.

To prevent its further spread, isolating and/or destroy vector insects is important. The odorants of the disclosure provide new and useful compositions for insect repellents, masking agents and traps. The class of compound described and identified by the method of the disclosure include volatile odorants that can mask or repel psyllids at various concentrations and can be easily dispersed in the air and have the potential to protect crops within a large area. Furthermore, the odorants of the disclosure which can spread over large areas may be adopted more easily in developing countries due to ease of delivery. The compounds of the disclosure are useful in small quantities, can be delivered in multiple forms like vapors and gels, are economical, environmentally friendly, and are present in natural sources.

Based upon the data and chemical odorants identified herein, additional odorants can be identified using the structural information of the odorants, in silico modeling and screening, and biological assays.

Host-odor cues, among others, are detected by olfactory receptor neurons (ORNs) that are present on the surface of at least two types of olfactory organs, the antennae and the maxillary palps. The antenna is the main olfactory organ and its surface is covered by hundreds of sensilla, each of which is innervated by the dendrites of 1-5 ORNs. Odor molecules pass through pores on the surface of sensilla and activate odor receptor proteins present on the dendritic membranes of the ORNs.

The odor receptor (Or) gene family in insects was first identified in D. melanogaster. It comprises a highly divergent family of 60 odor receptor (Or) genes that encode proteins predicted to contain seven trans-membrane regions.

Odor responses of ORNs on the surface of the antennae and maxillary palps have been studied using two separate techniques. Whole organ recordings called electroantennograms (EAGs) and electropalpograms (EPGs) have been used to detect the aggregate electrical activities from a large number of neurons in response to odors. A more sensitive and exact method has also been used to examine the functional properties of olfactory neurons within a single sensillum, and neurons that respond to behaviourally important ligands such as CO₂, ammonia, phenols, 1-octen-3-ol, lactic acid, and carboxylic acids have been identified.

Traditional vector control methods often involve the heavy use of chemical insecticides that are harmful to the environment and often to human health. Moreover, insects can develop resistance to these chemicals, suggesting that there is a need to identify novel ways of insect control that are effective, cheap, and environmentally friendly.

In order to transmit disease, a vector insect needs to find and feed on a host. For most vector insects attraction to a host is mediated primarily by volatile cues that are detected by the olfactory system of the insect.

The disclosure provides a group of volatile chemicals that can be used to modify host-seeking behavior by disrupting or stimulating ORN activities in psyllids. More specifically, the disclosure provides structures of volatile chemicals that strongly inhibit or activate olfactory neurons in psyllids, and can potentially modify insect behavior. The structural features of the inhibitory odorants provided can enable identification of additional structurally-related response inhibitory odorants using assays described herein and structure activity relationships (SAR).

An antagonist refers to a compound that can reversibly or irreversibly inhibit that activity of a sensing neuron or activates the sensing neuron (i.e., an ORN) upon exposure to the compound such that the neuron ORN cannot properly signal upon a change in odor levels.

The compounds and compositions of the disclosure can be used as antagonist to mask the chemoattractant activity of normally utilized by the insect to find its host. The compounds and compositions can be used as attractants alone or in combination with an insecticide, trap, or other mechanical, electrical or chemical that kills the insect or prevents its escape.

Furthermore, based upon the compounds identified herein, a structure based search followed by biological assays may be performed to identify compounds having a desired effect on receptors in psyllids.

Structure-based clustering can be used to identify compounds useful in compositions of the disclosure. The algorithm can include linkage clustering to join compounds into similarity groups, where every member in a cluster shares with at least one other member a similarity value above a user-specified threshold.

The identified compounds can then be assayed to identify their biological activity using the electrophysiology measurements described below. For example, a compound can be contacted with a receptor neuron and changes in the electrical signal measured. Alternatively, the compounds may be screened in a psyllid attraction or avoidance assays.

The disclosure provides chemicals that can be used as insect repellents and/or masking agents by virtue of their property to block a critical component of the host odor cue. The compounds are effective if they are capable of inhibiting the electrophysiological response of a psyllid ORN.

The volatile compounds of the disclosure have masking and repellant effects by impairing the ability to find a host via long-range cues emitted from, for example, citrus groves.

The disclosure provides a method of controlling insect attraction to a citrus grove, the method comprising the step of inhibiting receptor activation of an ORN in a psyllid or overstimulating the receptor with an antagonist (or a combination of antagonists) thereby controlling insect attraction to the subject.

In another embodiment, this disclosure provides a method of inhibiting, preventing or reducing the incidence of Huanglongbing disease, the method comprising the step of overstimulating or antagonizing a receptor in a psyllid (e.g., ACP) with a compounds or combination of compounds as described herein to capture or lure the insect thereby inhibiting, preventing or reducing the incidence of insect-borne disease.

The compounds may be used alone or in combination. The compounds of the disclosure may be combined with additional active agent, insecticides and the like in traps to reduce the presence of amount of an insect in the environment. For example, compounds of the disclosure may be used in combination with insect traps (e.g., tape, combustibles, and electric traps).

In yet a further embodiment, the compounds may be formulated for application to a tree, plant or other agricultural crop subject to infection by a psyllid (e.g., an ACP). The compounds of the disclosure can “mask” the location of a crop by antagonizing the receptor neurons of the insect thereby inhibiting the insect's ability to locate the host.

For example, the compounds of the disclosure may be used as repellants or in compositions comprising said repellant compounds and the use of such repellant compounds and compositions in controlling pests, particularly insect pests.

Liquid formulations may be aqueous-based or non-aqueous (e.g., organic solvents), or combinations thereof, and may be employed as lotions, foams, gels, suspensions, emulsions, microemulsions or emulsifiable concentrates or the like. The formulations may be designed to be slowly release from a patch or canister.

The compositions may comprise various combinations of compounds as well as varying concentrations of the compound depending upon the insect to be repelled or masked, the type of surface that the composition will be applied to, or the type of trap to be used.

The compounds according to the disclosure may be employed alone or in mixtures with one another and/or with such solid and/or liquid dispersible carrier vehicles as described herein or as otherwise known in the art, and/or with other known compatible active agents, including, for example, insecticides, acaricides, rodenticides, fungicides, bactericides, nematocides, herbicides, fertilizers, growth-regulating agents, and the like, if desired, in the form of particular dosage preparations for specific application made therefrom, such as solutions, emulsions, suspensions, powders, pastes, and granules as described herein or as otherwise known in the art which are thus ready for use.

The repellant compounds may be administered with other insect control chemicals, for example, the compositions of the disclosure may employ various chemicals that affect insect behavior, such as insecticides, attractants and/or repellents, or as otherwise known in the art. The repellant compounds may also be administered with chemosterilants.

In yet another aspect, the volatile compounds of the disclosure may be emitted from vaporizers, treated mats, cylinders, oils, candles, wicked apparatus, fans and the like. Liquid source that can evaporate to form vapors may be used in barns, houses, or patios.

The disclosure also provides chemicals that can be used as bait to lure insects to traps by virtue of activating neurons. An advantage of these odorants will be their ability to be delivered in an economical and convenient form for use with traps. This function can be achieved by applying or locating the chemoattractant compound of the disclosure near a suction based, or light based, or electric current based or other forms of trapping apparatus.

The following examples are intended to illustrate but not limit the disclosure. While they are typical of those that might be used, other procedures known to those skilled in the art may alternatively be used.

### EXAMPLES

The Asian Citrus Psyllid (ACP), Diaphorina citri Kuwayam, transmits the bacterium Candidatus Liberibacter, which causes the deadly Huanglongbing (HLB), or Citrus Greening Disease, a major threat to the citrus industry globally. The stage of invasion that the citrus industry is experiencing urges for an effective strategy to suppress the spread of the ACP population and prevent Huanglongbing transmission. Semiochemicals are very extensively used in IPM programs for other pest insects and can be environmentally safe, cheap, convenient, and usable in conjunction with other control methods. The disclosure provides novel odor-based lures and/or repellents for use in surveillance traps and for reducing contact of ACP with citrus plants. Several citrus and guava volatiles have been identified that activate (>50 spike/second) and inhibit (>50% of spontaneous activity) ACP olfactory neurons through single-sensillum electrophysiology assays. One-, two-, and three-odor blend lures consisting of chemicals have been identified that attract ACP by such biological assays.

This is the first time that the responses of ACP olfactory neurons to odorants have been examined. Prior to the present disclosure specific odors had been identified that that activate specific odor receptor neurons.

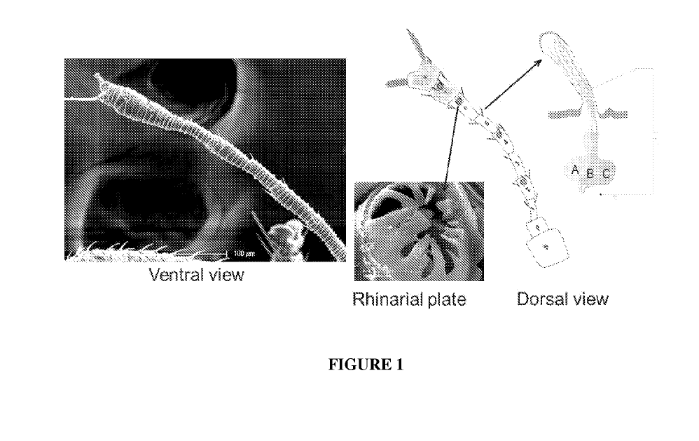

FIG. 1 shows the olfactory system in the ACP. Scanning Electron micrograph of an ACP antenna (left), with a schematic indicating olfactory sensilla, and schematic of a single hair-like sensilla containing the dendrites of 3 neurons A, B and C with a recording electrode inserted. The antennal flagellomeres are numbered and the circles indicate the rhinarial plates with pit-like sensilla. Hair-like structures are non-olfactory sensilla.

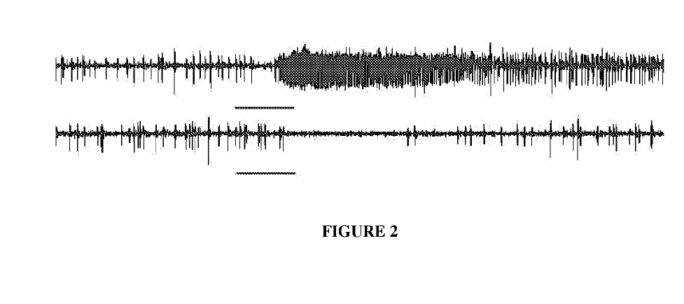

FIG. 2 shows representative traces from an ORN in ACP. Representative trace from sensillum in rhinarial plate 6 of ACP showing responses to a 0.5 second stimulus (indicated by bars) of odors (dilution 1%). Neurons show specific activity to different odors: example of neuron activation (top) and neuron inhibition (bottom).

Table 1 shows the odor-response spectra of 12 different classes of neurons. Odor-response spectra of 12 different classes of neurons housed in the rhinarial plates on flagellomeres 2, 4, 6 and 7. All odor responses indicate the frequency of action potentials of the neuron during the odor stimulus minus the baseline activity before the stimulus. All odors were diluted to 1% and 50 μL was placed in an odor delivery cartridge and applied through a controlled stimulus device to the insect antenna.

TABLE 1

| | 2A | 2B | 2C | 4A | 4B | 4C | 6A | 6B | 6C | 7A | 7B | 7C |
|---|---|---|---|---|---|---|---|---|---|---|---|---|
| sabinene hydrate | 0 | 0 | 0 | 0 | ++ | 0 | 0 | ++ | 0 | 0 | 0 | 0 |
| δ-3-carene | 0 | 0 | 0 | 0 | ++ | 0 | 0 | ++ | 0 | 0 | 0 | 0 |
| terpinolene | 0 | 0 | 0 | 0 | + | 0 | 0 | + | 0 | 0 | 0 | 0 |
| E-β-Ocimene | 0 | 0 | ++ | 0 | 0 | 0 | 0 | 0 | 0 | 0 | 0 | 0 |
| α-humulene | 0 | ++ | 0 | 0 | 0 | 0 | 0 | 0 | 0 | 0 | ++ | 0 |
| myrcene | 0 | 0 | ++ | 0 | + | 0 | 0 | + | 0 | 0 | 0 | 0 |
| citral | 0 | 0 | ++ | 0 | 0 | 0 | 0 | 0 | 0 | 0 | 0 | 0 |
| α-terpinene | 0 | 0 | 0 | 0 | ++ | 0 | 0 | ++ | 0 | 0 | 0 | 0 |
| (+)-limonene | 0 | 0 | + | 0 | + | 0 | 0 | + | 0 | 0 | 0 | 0 |
| (+)-carvone | 0 | 0 | 0 | 0 | ++ | 0 | 0 | ++ | 0 | 0 | 0 | 0 |
| perillaldehyde | 0 | 0 | − | 0 | + | 0 | 0 | + | 0 | 0 | 0 | 0 |
| citronellal | 0 | 0 | + | 0 | 0 | 0 | 0 | 0 | 0 | 0 | 0 | 0 |
| ZE-α-farnesene | 0 | 0 | + | 0 | 0 | 0 | 0 | 0 | 0 | 0 | 0 | 0 |
| β-caryophyllene | 0 | ++ | 0 | 0 | 0 | 0 | 0 | 0 | 0 | 0 | + | 0 |
| γ-terpinene | 0 | 0 | 0 | 0 | +++ | 0 | 0 | ++ | 0 | 0 | 0 | 0 |
| (−)-limonene | 0 | 0 | 0 | 0 | + | 0 | 0 | + | 0 | 0 | 0 | 0 |
| (−)-α-pinene | 0 | 0 | 0 | 0 | + | − | 0 | + | 0 | 0 | 0 | 0 |
| (−)-β-pinene | 0 | 0 | 0 | 0 | + | − | 0 | + | 0 | 0 | 0 | 0 |
| Z2-hexanol | 0 | 0 | 0 | 0 | + | 0 | 0 | + | 0 | 0 | 0 | 0 |
| 1-hexanol | 0 | 0 | 0 | 0 | + | 0 | 0 | + | 0 | 0 | 0 | 0 |
| Z3-hexenol | 0 | 0 | 0 | 0 | + | 0 | 0 | + | 0 | 0 | 0 | 0 |
| 1-octen-3-ol | 0 | 0 | 0 | 0 | 0 | 0 | 0 | + | 0 | 0 | 0 | 0 |
| 1 -octanol | 0 | 0 | 0 | 0 | + | 0 | 0 | + | 0 | 0 | 0 | 0 |
| decanal | 0 | 0 | 0 | 0 | +++ | 0 | 0 | ++ | 0 | 0 | 0 | ++ |
| nonanal | 0 | 0 | 0 | 0 | ++ | 0 | 0 | ++ | 0 | 0 | 0 | ++ |
| Z3-hexenal | 0 | 0 | 0 | ++ | 0 | 0 | ++ | 0 | 0 | 0 | + | 0 |
| octanal | 0 | + | 0 | + | 0 | + | + | 0 | + | 0 | ++ | 0 |
| E2-hexenal | 0 | 0 | ++ | 0 | + | 0 | 0 | + | 0 | 0 | 0 | 0 |
| isobutyl acetate | 0 | 0 | 0 | 0 | ++ | 0 | 0 | ++ | 0 | 0 | 0 | 0 |
| pentyl acetate | 0 | 0 | ++ | 0 | + | 0 | 0 | ++ | 0 | 0 | 0 | 0 |
| ethyl butyrate | 0 | 0 | + | 0 | +++ | 0 | 0 | ++ | 0 | 0 | 0 | ++ |
| methyl butyrate | 0 | 0 | 0 | 0 | ++ | 0 | 0 | + | 0 | 0 | 0 | + |
| water | 0 | 0 | 0 | 0 | 0 | + | 0 | 0 | + | 0 | 0 | 0 |
| p-cymene | 0 | 0 | 0 | 0 | +++ | 0 | 0 | ++ | 0 | 0 | 0 | 0 |
| acetophenone | 0 | 0 | 0 | 0 | ++ | 0 | 0 | ++ | 0 | 0 | 0 | + |
| methyl salicylate | 0 | 0 | 0 | 0 | + | 0 | 0 | + | 0 | 0 | + | 0 |
| benzaldehyde | 0 | 0 | + | 0 | + | 0 | 0 | 0 | 0 | 0 | 0 | 0 |
| phenylacetaldehyde | 0 | 0 | 0 | 0 | + | 0 | 0 | + | 0 | 0 | 0 | 0 |
| 2-pentanone | 0 | 0 | 0 | 0 | + | 0 | 0 | + | 0 | 0 | 0 | 0 |
| 2-heptanone | 0 | 0 | + | 0 | + | 0 | 0 | + | 0 | 0 | 0 | 0 |
| 6-methyl-5-hepten-2-one | 0 | 0 | + | 0 | 0 | 0 | 0 | 0 | 0 | 0 | 0 | 0 |
| dipropyl disulfide | 0 | 0 | 0 | 0 | + | 0 | 0 | ++ | 0 | 0 | 0 | 0 |
| allyl disulfide | 0 | 0 | 0 | 0 | ++ | 0 | 0 | + | 0 | 0 | 0 | 0 |
| diallyl trisulfide | 0 | 0 | 0 | 0 | + | 0 | 0 | + | 0 | 0 | 0 | 0 |

Legend: 0, no response; +, >50 spikes/second; ++, >100 spikes/second; +++ >150 spikes/second.

Table 2 shows responses of 12 ORNs to inhibitory odors. All odor responses indicate the frequency of action potentials of the neuron during the odor stimulus minus the baseline activity before the stimulus. All odors were diluted to 10⁻² and 50 μL was placed in an odor delivery cartridge and applied through a controlled stimulus device to the insect antenna.

TABLE 2

| | 2A | 2B | 2C | 4A | 4B | 4C | 6A | 6B | 6C | 7A | 7B | 7C |
|---|---|---|---|---|---|---|---|---|---|---|---|---|
| perillaldehyde | 0 | 0 | — | 0 | 0 | 0 | 0 | 0 | 0 | 0 | 0 | 0 |
| ethyl hexanoate | 0 | 0 | 0 | 0 | 0 | 0 | 0 | 0 | 0 | 0 | 0 | — |
| n-octyl acetate | 0 | 0 | 0 | 0 | — | 0 | 0 | 0 | 0 | 0 | 0 | 0 |
| isobutyric acid | 0 | 0 | 0 | 0 | — | — | 0 | 0 | — | 0 | 0 | 0 |
| propionic acid | 0 | 0 | 0 | 0 | — | 0 | 0 | — | 0 | 0 | 0 | 0 |
| acetic acid | 0 | 0 | 0 | 0 | — | 0 | 0 | — | 0 | 0 | 0 | — |
| pentanoic acid | 0 | 0 | 0 | 0 | 0 | 0 | 0 | 0 | 0 | 0 | — | 0 |
| 2,3-butanedione | 0 | — | 0 | 0 | 0 | 0 | 0 | 0 | 0 | 0 | 0 | 0 |
| β-butyrolactone | 0 | 0 | 0 | 0 | — | 0 | 0 | 0 | 0 | 0 | 0 | 0 |
| N-methylpiperidine | 0 | 0 | 0 | 0 | 0 | 0 | 0 | 0 | 0 | 0 | 0 | — |
| dimethyl amine | 0 | 0 | 0 | 0 | 0 | 0 | 0 | 0 | — | 0 | 0 | — |
| putrescine dihydrochloride | 0 | — | 0 | 0 | 0 | 0 | 0 | 0 | 0 | 0 | 0 | 0 |
| hexylamine | 0 | 0 | 0 | 0 | 0 | — | 0 | 0 | 0 | 0 | 0 | 0 |
| pentylamine | 0 | — | 0 | 0 | 0 | — | 0 | 0 | 0 | 0 | 0 | 0 |
| pyridine | 0 | 0 | 0 | 0 | 0 | — | 0 | 0 | 0 | 0 | 0 | 0 |

Table 3 show responses of 12 ORNs to ultra-prolonged activators. Odors evoked ultra-prolonged tonic responses (lasting at least 8 seconds) upon stimulation from an odor puff of 0.5 sec. Each odor was diluted at 10⁻² concentration in paraffin oil and 50 μL placed in an odor cartridge and delivered through a controlled stimulus device to the insect antenna.

TABLE 3

| | 2A | 2B | 2C | 4A | 4B | 4C | 6A | 6B | 6C | 7A | 7B | 7C |
|---|---|---|---|---|---|---|---|---|---|---|---|---|
| (+)-carvone | 0 | 0 | 0 | 0 | ++ | 0 | 0 | ++ | 0 | 0 | 0 | 0 |
| 1-hexanol | 0 | 0 | 0 | 0 | + | 0 | 0 | + | 0 | 0 | 0 | 0 |
| nonanal | 0 | 0 | 0 | 0 | ++ | 0 | 0 | ++ | 0 | 0 | 0 | ++ |

Table 4 shows results from a field trial. Yellow sticky traps holding a chemical lure at either the southwest or northeast side of the same citrus tree whereas similar trap holding a blunder was set up at the contralateral side. A chemical lure consisted of p-cymene, ethyl butyrate, and myrcene and was deployed in open plastic bags containing three glass vials filled with one of each chemical (at 5% concentration in solvent). Catches were carried out between March 1^{st} and May 9^{th}. Differences between odor blend-baited and solvent-baited traps are statistically significant (p=0.01, paired t-test). Preference index was calculated using the equation: PI=(#odor blend−#control)/(#odor blend+#control), where # is the average number of psyllids caught per treatment. n=7. Std; Standard deviation. SEM: Standard error of mean. Solvent: paraffin oil.

TABLE 4

| | Preference |
|---|---|
| | index |
| Mean | 0.50 |
| Std | 0.22 |
| n | 7 |
| SEM | 0.08 |

Behaviorally modifying compounds can be delivered in multiple forms including vapors, lotions, sprays, coated fabrics, etc.

A number of embodiments of the invention have been described. Nevertheless, it will be understood that various modifications may be made without departing from the spirit and scope of the invention. Accordingly, other embodiments are within the scope of the following claims.

1. A method of attracting a psyllid comprising exposing the psyllid with an attracting composition comprising one or more compounds selected from the group consisting of sabinene hydrate, δ-3-carene, terpinolene, E-β-Ocimene, α-humulene, myrcene, citral, α-terpinene, (+)-limonene, (+)-carvone, perillaldehyde, citronellal, ZE-α-farnesene, β-caryophyllene, γ-terpinene, (−)-limonene, (−)-α-pinene, (−)-β-pinene, Z2-hexanol, 1-hexanol, Z3-hexenol, 1-octen-3-ol, 1-octanol, decanal, nonanal, Z3-hexenal, octanal, E2-hexenal, isobutyl acetate, pentyl acetate, ethyl butyrate, methyl butyrate, β-cymene, acetophenone, methyl salicylates, benzaldehyde, phenylacetaldehyde, 2-pentanone, 2-heptanone, 6-methyl-5-hepten-2-one, dipropyl disulfide, allyl disulfide, and diallyl trisulfide.

2. (canceled)

3. The method of claim 1, wherein the attracting composition comprises p-cymene, ethyl butyrate, and myrcene, and optionally acetophenone.

4. (canceled)

5. The method of claim 1, wherein the attracting composition comprises one or more compounds selected from the group consisting of myrcene, δ-3-carene, terpinolene, (E)-β-ocimene, β-caryophyllene, α-humulene, and D-limonene.

6-10. (canceled)

11. The method of claim 1, wherein the composition further comprises two or more compounds each independently selected from the group consisting of a C10-C15 terpene; a C10-C15 terpenoid; a C6-C8 alcohol; a C5-C7 ester; a C7-C10 compound containing an aromatic ring; a C6-C10 aldehyde; a C5-C8 ketone; and a S2-S3, C6 sulfur compound.

12. The method of claim 1, wherein the psyllid attracting composition comprises a vapor, and wherein the vapor is emitted from a vaporizer, treated mat, treated pod, absorbed material, cylinder, oil, candle, wicked apparatus, or fan.

13. The method of claim 1, wherein the psyllid attracting composition comprises a liquid, and wherein the liquid evaporates to a vapor within or near a psyllid trap entrance.

14. The method of claim 1, wherein the exposing the psyllid with the psyllid attracting composition is carried out using suction, light, an electric current, or any combination thereof.

15. A method of repelling a psyllid comprising exposing the psyllid with a psyllid repelling composition comprising one or more compounds each independently selected from the group consisting of a C4-C6 diketone; a C4 lactone; a C8-15 ester; a C2-C5 carboxylic acid; a C2-C6 amine; and a C5-C6, N1-N2 heterocycle.

16. The method of claim 0, wherein the psyllid repelling composition comprises one or more compounds selected from the group consisting of perillaldehyde; ethyl hexanoate; n-octyl acetate; isobutyric acid; propionic acid; acetic acid; pentanoic acid; 2,3-butanedione; β-butyrolactone; N-methylpiperidine; dimethyl amine; putrescine dihydrochloride; hexylamine; pentylamine; pyridine; (+)-carvone; 1-hexanol; and nonanal.

17. The method of claim 15, wherein the psyllid repelling composition comprises one or more compounds selected from the group consisting of (+)-carvone; 1-hexanol; and nonanal.

18-19. (canceled)

20. The method of claim 15, wherein the psyllid repelling composition comprises one or more compounds selected from the group consisting of hexylamine, pentylamine, pyridine, 2-phenylethanamine, dimethylamine, acetic acid, and propionic acid.

21. (canceled)

22. The method of claim 15, wherein the psyllid repelling composition is formulated as a lotion, cream, spray, or dust.

23. The method of claim 15, wherein the exposing the psyllid with the psyllid repelling composition is carried out using a vaporizer, a treated mat, treated outerwear, an oil, a candle, or a wicked apparatus.

24. The method of claim 15, wherein the exposing the psyllid with the psyllid repelling composition comprises applying to an object an effective amount of the psyllid repelling composition to repel the psyllid.

25. The method of claim 15, wherein the exposing comprises applying the psyllid repelling composition on or near a plant.

26. The method of claim 15, wherein the exposing comprises applying the psyllid repelling composition to an article, and wherein the article is suspended on a citrus plant.

27. The method of claim 1, wherein the psyllid is an Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and a psyllid of the family Psyllidae (Hemiptera).

28. The method of claim 27, wherein the psyllid is an Asian Citrus Psyllid (Diaphorina citri).

29. An insect attractant composition comprising a compound of claim 1 and one or more compounds selected from the group consisting of (+)-carvone; 1-hexanol; and nonanal.

30. (canceled)

31. The method of claim 15, wherein the psyllid is an Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and a psyllid of the family Psyllidae (Hemiptera).
